(19) United States
(12) Patent Application Publication
(10) Pub. No.: US 2024/0261889 A1
(43) Pub. Date: Aug. 8, 2024

(54) FRICTION STIR SPOT WELDING APPARATUS

(71) Applicant: HONDA MOTOR CO., LTD., Tokyo (JP)

(72) Inventors: Akiyoshi MIYAWAKI, Wako-shi (JP); Taichi KURIHARA, Wako-shi (JP)

(21) Appl. No.: 18/422,889

(22) Filed: Jan. 25, 2024

(30) Foreign Application Priority Data
Feb. 3, 2023 (JP) 2023-015018

(51) Int. Cl. B23K 20/12

(52) U.S. Cl. CPC B23K 20/1265; B23K 20/1255

(57) ABSTRACT

A friction stir spot welding apparatus is configured to friction-stir-weld a plurality of materials including a plate-shaped first material and a second material disposed in contact with a facing surface of the first material and comprises a probe rotatable about a central axis. The probe includes a pin portion protruding along the central axis from a bottom surface of a cylindrical shoulder portion. The probe also includes an inner wall surface including a circumferential surface protruding from the shoulder portion with a constant distance from the central axis and a spaced surface provided continuously along with the circumferential surface and positioned outward from the circumferential surface.

### CROSS-REFERENCE TO RELATED APPLICATIONS

The present application claims priority under 35 U.S.C. § 119 to Japanese Patent Application No. 2023-015018, filed Feb. 3, 2023, the contents of which are hereby incorporated by reference in their entirety.

### BACKGROUND OF THE INVENTION

### 1. Field of the Invention

The present invention relates to a friction stir spot welding apparatus.

### 2. Description of the Related Art

JP 2010-23068 A (Patent Document 1) discloses a friction stir welding tool for spot welding for laminated plate materials including at least an upper plate and a lower plate, which includes: a cylindrical main shaft portion; a shoulder surface formed at one end of the main shaft portion; a pin portion protruding from the shoulder surface and having a smaller diameter than the shoulder surface; and a burr preventing portion protruding radially outward from an outer peripheral surface of the main shaft portion.

In this technique, a gap portion is formed in a lower surface of the burr preventing portion and extends radially outward from the main shaft portion. This gap portion is formed between the outer peripheral surface of the main shaft portion and the outer peripheral edge of the burr preventing portion, which provides a space to allow a burr generated around a joint during joining to enter. Securing the space for the burr to protrude prevents the burr from contacting the burr preventing portion and being fused, and prevents plastic flow around the joint from being obstructed.

### SUMMARY OF THE INVENTION

However, even with the technique of Patent Document 1, by securing space in the gap portion into which the burr can protrude, the burr is formed so that a tip thereof spreads outward (see reference numeral 9 in FIG. 8 of Patent Document 1). Therefore, when the plate materials are electrocoated after the friction-stir-spot-welding, coating defects are likely to occur around the burr. To reduce such coating defects, a process of removing the burr must be provided after the friction-stir-welding process, which leads to increasing manufacturing costs due to the extra process.

In response to that, the present invention provides a friction stir spot welding apparatus capable of reducing extra manufacturing costs when coating friction-stir-welded workpieces. The present invention provides a friction stir spot welding apparatus configured to friction-stir-weld a plurality of materials including a plate-shaped first material and a second material disposed in contact with a facing surface of the first material and comprising a probe rotatable about a central axis. The probe includes a pin portion protruding along the central axis from a bottom surface of a cylindrical shoulder portion, and an inner wall surface including: a circumferential surface protruding from the shoulder portion with a constant distance from the central axis; and a spaced surface provided continuously along with the circumferential surface and positioned outward from the circumferential surface.

According to the present invention, it is possible to provide a friction stir spot welding apparatus capable of reducing extra manufacturing costs when coating friction-stir-welded workpieces.

### BRIEF DESCRIPTION OF THE DRAWINGS

FIG. 1 is a plan view of a friction stir spot welding apparatus according to Embodiment 1 as viewed from an insertion side.

FIG. 2 is a perspective view of the friction stir spot welding apparatus according to Embodiment 1 as viewed from the insertion side.

FIG. 3 is a longitudinal sectional view for explaining an operation of the friction stir spot welding apparatus over time according to Embodiment 1.

FIG. 4 is a longitudinal sectional view for explaining the operation of the friction stir spot welding apparatus over time according to Embodiment 1.

FIG. 5 is a longitudinal sectional view for explaining the operation of the friction stir spot welding apparatus over time according to Embodiment 1.

FIG. 6 is a longitudinal sectional view of a welded workpiece according to Embodiment 1 after friction-stir-welding.

FIG. 7 is a plan view of the welded workpiece according to Embodiment 1 after the friction-stir-welding.

FIG. 8 is a plan view of a friction stir spot welding apparatus according to Embodiment 2 as viewed from an insertion side.

FIG. 9 is a perspective view of the friction stir spot welding apparatus according to Embodiment 2 as viewed from the insertion side.

FIG. 10 is a plan view of a friction stir spot welding apparatus according to Embodiment 3 as viewed from an insertion side.

FIG. 11 is a perspective view of the friction stir spot welding apparatus according to Embodiment 3 as viewed from the insertion side.

FIG. 12 is a longitudinal sectional view of a workpiece during friction-stir-welding according to Embodiment 3.

FIG. 13 is a sectional view taken along a line A-A in FIG. 12.

### DETAILED DESCRIPTION OF THE EMBODIMENTS

The following describes multiple embodiments of the present invention.

### Embodiment 1

The friction stir spot welding apparatuses according to each embodiment join multiple materials (workpieces) together by friction-stir-spot-welding. The materials include a plate-shaped first material and a second material disposed in contact with a facing surface of the first material.

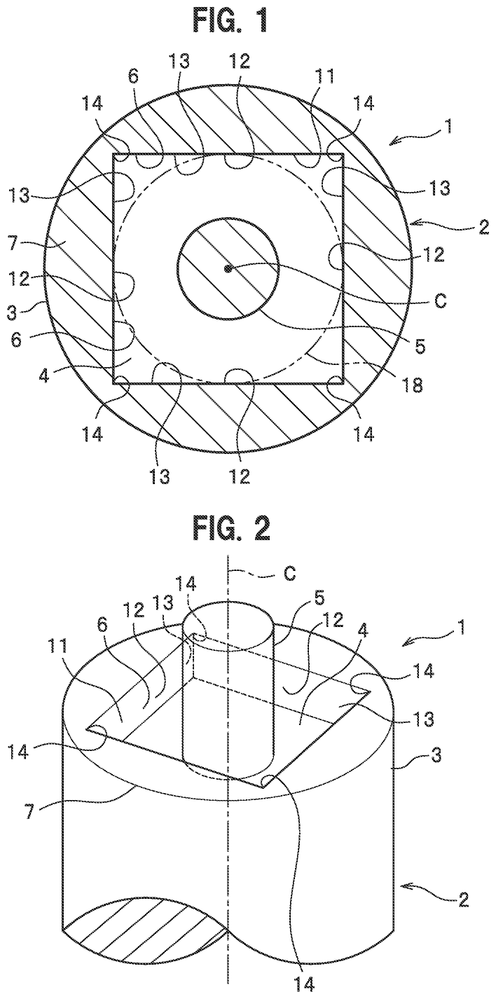

FIG. 1 is a plan view of the friction stir spot welding apparatus according to Embodiment 1 as viewed from the insertion side. FIG. 2 is a perspective view of the same friction stir spot welding apparatus as viewed from the insertion side.

This friction stir spot welding apparatus 1 includes a probe 2 rotatable about a central axis C. FIGS. 1 and 2 show only the insertion side (potion closer to a distal end) of this probe 2. A portion closer to proximal end of the probe 2 is supported by a not-shown robotic arm, and is configured to spot-weld a desired portion of the workpiece (any portion where the first material and second material overlap) by the friction-stir-welding.

The probe 2 includes a cylindrical shoulder portion 3 closer to the distal end. A cylindrical pin portion 5 protruding along the central axis C, or an axis center, toward the insertion side (the distal end) is provided on a bottom surface 4 of the shoulder portion 3. A recessed portion 6 recessed toward the proximal end of the probe 2 is formed around the pin portion 5 on the bottom surface 4. A protruding portion 7 protruding toward the insertion side (the distal end) is formed at an outer periphery of the recessed portion 6.

An inner wall surface 11, as an inner circumferential surface, of the protruding portion 7 protrudes from the shoulder portion 3 toward the insertion side (the distal end) and has a circumferential surface 12 and a spaced surface 13 which are provided alternately in the circumferential direction of the inner wall surface 11. The circumferential surface 12 has a constant distance from the central axis C. The spaced surface 13 is provided continuously along with the circumferential surface 12 and positioned outward from the circumferential surface 12. The circumferential surface 12 is defined as a surface which continuously extends from a part of an arc of imaginary circle 18 with a dash-double-dot line centered on the central axis C in FIG. 1 in a lengthwise direction of the probe 2. Meanwhile, in this Embodiment 1, the circumferential surface 12 is a very narrow surface that is a substantially linear surface merely in contact with the imaginary circle 18. In addition, the shape of the inner wall surface 11 as viewed from the insertion direction of the probe 2 is a polygonal shape. In the example of FIG. 1 or 2, the inner wall surface 11 is a quadrangular shape, but it may be a triangular shape or a pentagonal shape. Therefore, the inner wall surface 11 includes a corner portion 14 positioned farthest outward from the spaced surface 13.

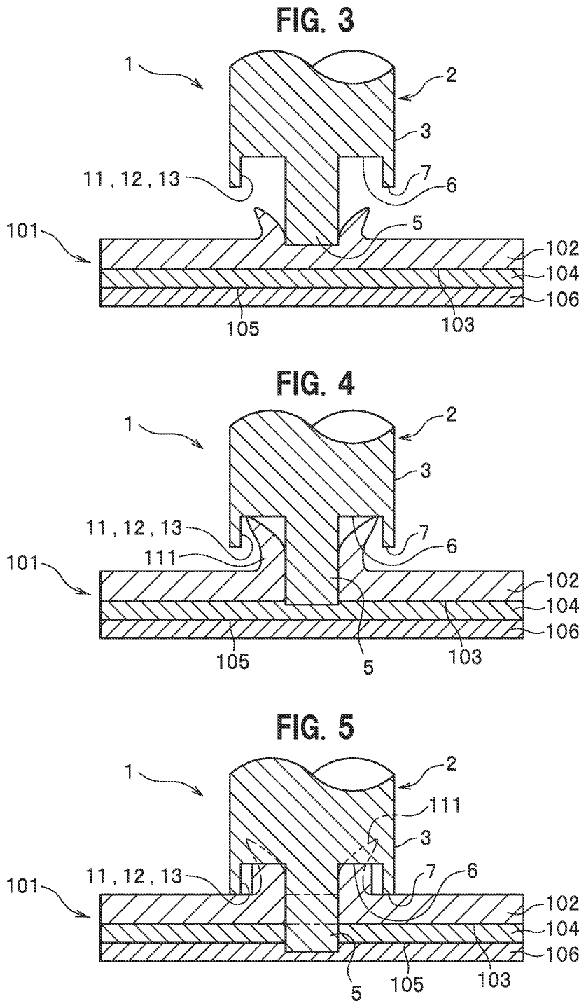

Next, an operation of the friction stir spot welding apparatus 1 will be described. FIGS. 3 to 5 are longitudinal sectional views explaining the operation of the friction stir spot welding apparatus 1 over time in this order. In FIG. 3, a workpiece 101 to be joined by the friction stir spot welding apparatus 1 is composed of multiple materials including a plate-shaped first material 102 and a second material 104 disposed in contact with a facing surface 103 of the first material 102. In this embodiment, the workpiece 101 also includes a third material 106 disposed in contact with a facing surface 105 of the second material 104. Naturally, the workpiece 101 may include only the first material 102 and the second material 104, or may additionally include a fourth material. Each material of the workpiece 101 is typically a metal material such as aluminum or iron.

First, the robotic arm described above manipulates the probe 2 to press the distal end of the probe 2 against the workpiece 101 and rotate the probe 2 (the shoulder portion 3 and the pin portion 5 also rotate in unison). This causes plastic flow around the pin portion 5 in the workpiece 101 and the pin portion 5 is pressed into the workpiece 101.

Next, as shown in FIG. 4, the pin portion 5 is pressed deeper into the workpiece 101 than in the step of FIG. 3. This produces a burr 111 around a portion where the pin portion 5 has been pressed into the workpiece 101, and the burr 111 grows outwardly as extending toward a tip thereof.

Next, as shown in FIG. 5, the pin portion 5 is pressed deeper into the workpiece 101 than in the step of FIG. 4. At this time, when the materials of the first material 102, second material 104, and third material 106 are the same, they are plasticized, stirred, and mixed together.

At this time, the burr 111 is restricted from protruding outward beyond the pin portion 5 and the inner wall surface 11 and kept between the pin portion 5 and inner wall surface 11. That is, the circumferential surface 12 shapes an outer periphery of the burr 111 in an annular surface shape, and providing the spaced surface 13 reduces the plastic flow of the burr 111 due to frictional heat between the circumferential surface 12 and the burr 111, thereby preventing the burr 111 from flowing outward beyond a lower end of the inner wall surface 11.

The lower end of the inner wall surface 11 (an end of the protruding portion 7) contacts a surface of the first material 102 when the pin portion 5 is pressed into the workpiece 101 to a target depth. Whether or not the pin portion 5 has reached the target depth in the workpiece 101 is determined by detecting a current position of the distal end of the probe 2 or sensing the surface of the workpiece 101. Therefore, the probe 2 is designed such that when the pin portion 5 reaches to the target depth in the workpiece 101, the lower end of the inner wall surface 11 (an end of the protruding portion 7) contacts the surface of the first material 102.

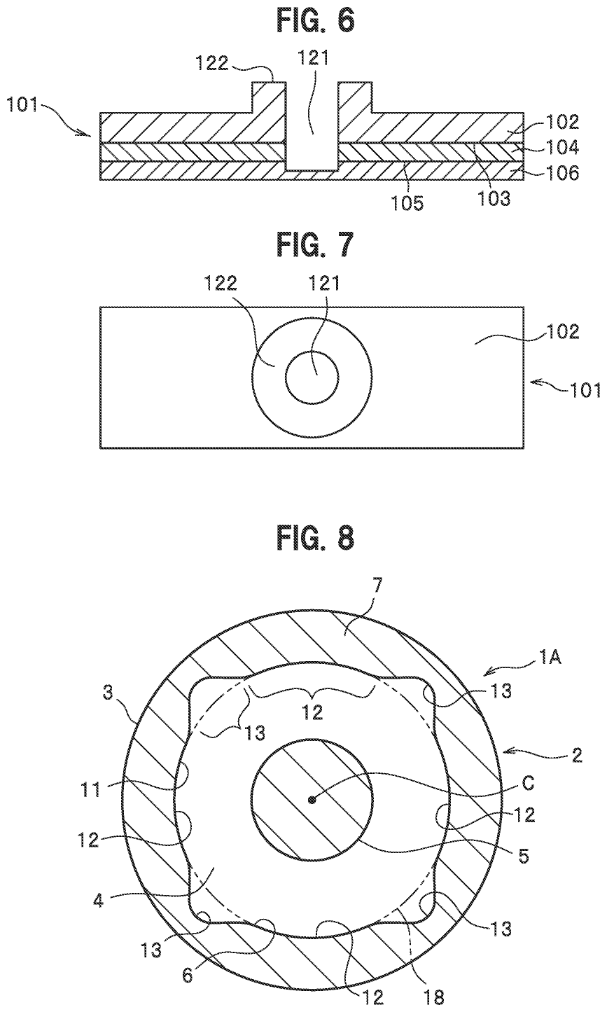

The workpiece 101 is friction-stir-welded through the above steps. FIG. 6 is a longitudinal sectional view of the workpiece 101 after the friction-stir-welding, and FIG. 7 is a plan view thereof. After the friction-stir-welding, the pin portion 5 is pulled out from the workpiece 101, thus leaving a hole 121. An inner periphery of this hole 121 is heated and stirred during the friction-stir-welding operation, but after completion of the operation, it is cooled and solidified, thereby joining the first material 102, the second material 104, and the third material 106 together. An annular protrusion 122 is formed around outside the hole 121. The protrusion 122 is formed from the burr 111 and its vertical cross-sectional shape is substantially rectangular.

As described above, after the friction-stir-welding of the workpiece 101, the burr 111 with an outwardly warped end does not appear, and the protrusion 122 with a rectangular cross section remains. Therefore, even if the workpiece 101 is electrocoated after the friction-stir-welding process without removing the protrusion 122, coating defects are unlikely to occur around the protrusion 122. Thus, the workpiece 101 is properly electrocoated without providing a process of removing the protrusion 122 after the friction-stir-welding process, thereby reducing extra manufacturing costs when coating the friction-stir-welded workpiece 101.

Further, the lower end of the inner wall surface 11 contacts the surface of the first material 102 when the pin portion 5 is pressed into the workpiece 101 to the target depth. Therefore, the lower end of the inner wall surface 11 contacts the surface of the workpiece 101, which prevents the burr 111 removed by cutting from coming out of the inner wall surface 11, thereby reducing the work of removing the burr 111.

Furthermore, the inner wall surface 11 has a polygonal shape as viewed from the distal end of the probe 2. That is, the inner wall surface 11 has a simple shape. This shape results in an excellent machinability of the inner wall surface 11 in the manufacturing process using the probe 2, thereby reducing the manufacturing costs.

### Embodiment 2

In each embodiment to be described below, members identical to the members in the previous embodiments are denoted by the same reference numerals, and detailed explanations thereof will be omitted.

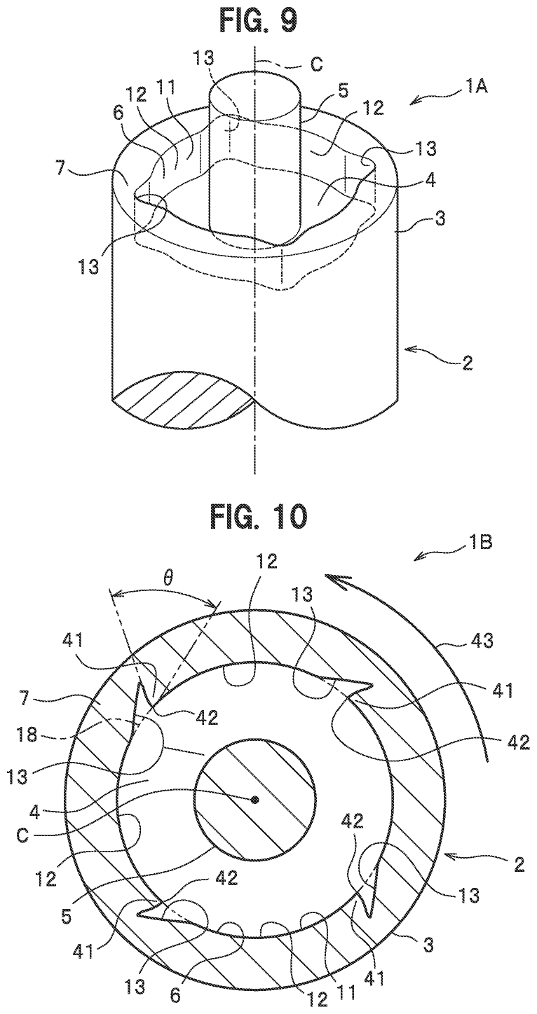

FIG. 8 is a plan view of a friction stir spot welding apparatus according to Embodiment 2 as viewed from the insertion side. FIG. 9 is a perspective view of the same friction stir spot welding apparatus as viewed from the insertion side.

The friction stir spot welding apparatus LA according to Embodiment 2 differs from the friction stir spot welding apparatus 1 according to Embodiment 1 in the following point. That is, a range of the circumferential surface 12 in the inner wall surface 11 as viewed from the insertion direction of the probe 2 is wider than a range of the spaced surface 13. In Embodiment 1, the range of the circumferential surface 12 is narrow and has a substantially linear surface. Meanwhile, in Embodiment 2, the circumferential surface 12 has the arc shape of the imaginary circle 18. That is, unlike Embodiment 1, the inner wall surface 11 of Embodiment 2 as viewed from the insertion direction of the probe 2 does not have a simple polygonal shape, but has a slightly more complex shape.

Thus, the range of the circumferential surface 12 gets wider than the range of the spaced surface 13 in the inner wall surface 11 as viewed from the insertion direction of the probe 2. This structure of Embodiment 2 achieves following functions and effects that cannot occur in the structure of Embodiment 1. That is, since the circumferential surface 12 has a constant distance from the central axis C to simply reshape the burr 111 during friction-stir-welding, the burr 111 does not serve as an excessively large resistance for the circumferential surface 12, while the range of the circumferential surface 12 in the inner wall surface 11 is wide. On the other hand, the spaced surface 13 shapes or cuts the burr 111 and the burr 111 serves as some degree of large resistance for the spaced surface 13. Meanwhile, this structure results in the narrow range of the spaced surface 13 and reduces the time for cooling the burr 111 heated by frictional heat between the circumferential surface 12 and the burr 111 to be cooled by the spaced surface 13, thereby reducing the resistance during shaping or cutting.

This reduces torque variation during rotation of the probe 2 during friction-stir-welding and allows the probe 2 to be smaller in size and have a longer service life.

### Embodiment 3

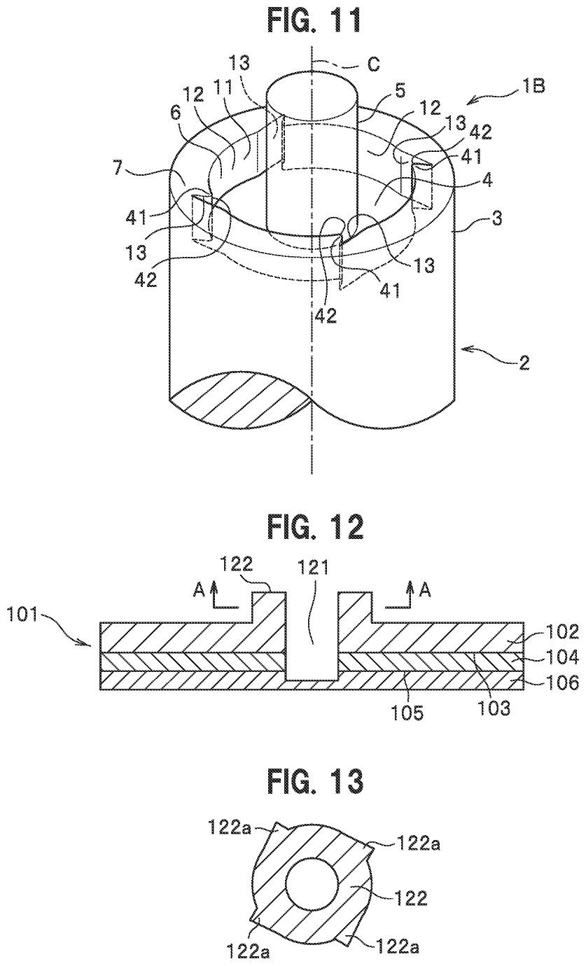

FIG. 10 is a plan view of a friction stir spot welding apparatus according to Embodiment 3 as viewed from the insertion side. FIG. 11 is a perspective view of the same friction stir spot welding apparatus as viewed from the insertion side.

The friction stir spot welding apparatus 1B according to Embodiment 3 differs from the friction stir spot welding apparatus LA according to Embodiment 2 in the following point. A structure of Embodiment 3 has front boundary portions and rear boundary portions 41 defined by the circumferential surface 12 and the spaced surface 13 in a rotational direction of the probe 2 (a direction indicated by an arrow 43). The rear boundary portions 41 are located at the rear of the front boundary portions in the rotational direction of the probe 2 respectively. At least the rear boundary portions 41 of the boundary portions each have an acute angle θ as viewed in a radial cross-section.

FIG. 12 is a longitudinal sectional view of a workpiece during friction-stir-welding according to Embodiment 3, and FIG. 13 is a sectional view taken along a line A-A in FIG. 12. As shown in FIG. 13, the protrusion 122, in the middle of its formation during friction-stir-welding, may create a projection 122a thereon. However, the rear boundary portion 41 in the rotational direction of the probe 2 has an acute angle θ between the circumferential surface 12 and the spaced surface 13 in the radial cross-section. That is, the tip 42 of the boundary portion 41 is edged and reliably cut off the projection 122a. This makes the burr 111 hardly remain on an outer periphery of the protrusion 122 and reduces a load on the probe 2. Further, the protrusion 122 is shaped into a clean annular shape, which reduces an occurrence of defects during subsequent electrocoating.

As described above for each embodiment, it is needless to say that each embodiment is merely a configurational example of the present invention, and the present invention can be implemented in various forms other than these.

What is claimed is:

1. A friction stir spot welding apparatus configured to friction-stir-weld a plurality of materials including a plate-shaped first material and a second material disposed in contact with a facing surface of the first material, comprising
a probe rotatable about a central axis,
wherein the probe includes
a pin portion protruding along the central axis from a bottom surface of a cylindrical shoulder portion and
an inner wall surface including: a circumferential surface protruding from the shoulder portion with a constant distance from the central axis; and a spaced surface provided continuously along with the circumferential surface and positioned outward from the circumferential surface.

2. The friction stir spot welding apparatus according to claim 1, wherein a lower end of the inner wall surface contacts a surface of the first material when the pin portion is pressed into the plurality of materials to a target depth.

3. The friction stir spot welding apparatus according to claim 1, wherein the inner wall surface as viewed from an insertion direction of the probe has a polygonal shape.

4. The friction stir spot welding apparatus according to claim 1, wherein a range of the circumferential surface is wider than a range of the spaced surface in the inner wall surface as viewed from an insertion direction of the probe.

5. The friction stir spot welding apparatus according to claim 1, wherein the circumferential surface and the spaced surface make a front boundary portion and a rear boundary portion therebetween in a rotational direction of the probe,
wherein the rear boundary portion is located at the rear of the front boundary portion in the rotational direction of the probe, and
wherein at least the rear boundary portion has an acute angle in a radial cross-section.
